(19) United States
(12) Patent Application Publication
(10) Pub. No.: US 2016/0115340 A1
(43) Pub. Date: Apr. 28, 2016

(54) HARD COAT FILM AND HARD COAT FILM WOUND BODY

(71) Applicant: NITTO DENKO CORPORATION, Osaka (JP)

(72) Inventors: Naoki Hashimoto, Ibaraki-shi (JP); Katsunori Takada, Ibaraki-shi (JP); Shinya Hiraoka, Ibaraki-shi (JP); Hiroki Kuramoto, Ibaraki-shi (JP)

(73) Assignee: NITTO DENKO CORPORATION, Ibaraki-shi, Osaka (JP)

(21) Appl. No.: 14/894,192

(22) PCT Filed: May 19, 2014
(86) PCT No.: PCT/JP2014/063160

§ 371 Date: Nov. 25, 2015

(30) Foreign Application Priority Data
May 27, 2013 (JP) 2013-110912

(51) Int. Cl. C09D 133/14; C08K 3/22

(52) U.S. Cl. CPC C09D 133/14; C08K 3/22; C08K 2003/2244

(57) ABSTRACT

Provide are a hard coat film which can exhibit high anti-blocking properties and high scratch resistance and simultaneously achieve high light transmittance (lower haze), and a wound body thereof. The present invention relates to a hard coat film including: a transparent polymer base material; and a hard coat layer formed on one main surface of the transparent polymer base material, wherein: the hard coat layer includes fine particles and a composite resin containing an organic component and an inorganic component; the hard coat layer has a surface having a flat portion and protrusion portions formed by the fine particles; and haze H_{particle} caused by the protrusion portions of the hard coat layer is 0.5% or less.

### TECHNICAL FIELD

The present invention relates to a hard coat film and a hard coat film wound body.

### BACKGROUND ART

While the market for a display product with a touch panel expands in recent years, the demand for a film member having a functional layer of low resistance (high conductivity) or the like increases. A conductive layer is generally provided by forming a metal oxide film by sputtering under a vacuum environment. When the sputtering is continuously performed by a roll-to-roll method, a base film wound into a roll shape is set under a vacuum environment, and thereby air between layers of the film in the roll escapes. This causes a decrease in a distance between the films. In an extreme case, the films adhere together (blocking). When the strongly adhering films are fed to travel on a line, the films are scratched when the films are peeled from the wound roll, or the films are scratched due to the fluttering while travelling on the line and at the time of contact with a guide roll. This may cause a large decrease in yield.

On the other hand, there are proposed various methods for preventing a film from being scratched by applying a blocking prevention function to the surface of the film. For example, in order to prevent blocking, there is proposed a technique of forming an uneven surface on a film by the phase separation of an oligomer and a monomer (Patent Document 1). However, a phase separation phenomenon is difficult to control in separation degree, i.e., control for forming uniform unevenness in a coating process. Therefore, coarse unevenness may be provided to cause drawbacks on the appearance. Conversely, when the unevenness is insufficiently formed, blocking prevention performance may be insufficient.

On the other hand, there is also proposed a technique in which anti-blocking properties are secured by adding particles into a film to form unevenness (Patent Documents 2 and 3). Similarly, there is proposed a technique in which a multi-layered thermoplastic resin containing particles provides projections on the surface of a film to form a highly transparent blocking prevention film, as an example of unevenness formation attempted by adding particles (Patent Document 4).

### PRIOR ART DOCUMENTS

### Patent Documents

Patent Document 1: JP-A-2009-123685

Patent Document 2: JP-A-2004-42653

Patent Document 3: JP 4673488 B2

Patent Document 4: JP 4228446 B2

### SUMMARY OF THE INVENTION

### Problems to be Solved by the Invention

Although the techniques of Patent Documents 1 and 2 sufficiently secure anti-blocking properties, the techniques provide a blocking prevention layer having high haze since a large amount of particles having a comparatively large particle diameter are added. This may make it difficult to achieve high transparency demanded in the market, or cause the coming off of the added particles. In the technique of Patent Document 3, the thermoplastic resin has insufficient scratch resistance derived from the material properties. Even if the thermoplastic resin has a certain level of blocking prevention performance, the thermoplastic resin causes the fear of the scratch or the like in the line under the special environment described above.

From the above viewpoints, it is an object of the present invention to provide a hard coat film which can exhibit high anti-blocking properties and high scratch resistance and simultaneously achieve high light transmittance (lower haze), and a wound body thereof.

### Means for Solving the Problems

As a result of intense investigations to solve the problems, the present inventors obtained the following findings. In order to exhibit blocking prevention performance from particles, it is necessary to form projections provided by the particles. From the viewpoints of a particle diameter, a refractive index, and high sphericity, organic particles made of styrene, methyl acrylate, and methyl methacrylate or the like are generally used as particles for forming the projections. These are dispersed in a binder, and the dispersion liquid is subjected to coating, drying, and curing processes to obtain a desired film. When the composition of the binder has only an organic material represented by urethane acrylate or the like, the particles settle out because of the specific gravity, which makes it difficult to form the projections on the surface of the film. In order to address the phenomenon, there is also considered a technique of making a film thickness extremely thinner relative to the particle diameters of added particles, to enlarge projections. However, this may increase the coming off of the added particles as in the defects in the known techniques or the like, which is not suitable after all. On the other hand, there is considered a method of adding a large amount of particles to increase the numbers of projections and recesses as means for obtaining required blocking prevention performance. However, this causes an increase in haze, i.e., a decrease in transparency.

As a result of further investigations based on the findings, the present inventors found that the objects are achieved by employing the following constitutions. The findings led to the completion of the present invention.

The present invention provides a hard coat film including: a transparent polymer base material; and a hard coat layer formed on one main surface of the transparent polymer base material. The hard coat layer includes fine particles and a composite resin containing an organic component and an inorganic component. The hard coat layer has a surface having a flat portion and protrusion portions formed by the fine particles. Haze H_{particle} caused by the protrusion portions of the hard coat layer is 0.5% or less.

In the hard coat film, the hard coat layer has a surface having the protrusion portions formed by the fine particles, and thereby the hard coat film can exhibit high anti-blocking properties. The haze H_{particle} caused by the protrusion portions of the hard coat layer is 0.5% or less, and thereby the visible light transmittance in the whole hard coat film can be improved. Furthermore, the composite resin containing the organic component and the inorganic component is used as a binder for forming the hard coat layer, and thereby high hardness can be exhibited by an improvement in elastic modulus, and good scratch resistance can be obtained. A method for measuring the haze H_{particle} is based on the description of Examples.

The reason why the haze H_{particle} caused by the protrusion portions of the hard coat layer can be suppressed low although the protrusion portions are formed by adding the fine particles is uncertain. However, the reason is presumed as follows. In the hard coat film, the composite resin containing the inorganic component is used as the binder. Since the specific gravity of the inorganic component is generally high, the specific gravity of the composite resin itself is also increased. As a result, the increased specific gravity suppresses the sedimentation of the fine particles added into the composite resin (in other words, the fine particles remain on the surface side of the hard coat layer), which facilitates the formation of the protrusion portions. The increased specific gravity suppresses also the outflow of the composite resin on the fine particles to the flat portion side, and the composite resin having a certain level of thickness exists also on the fine particles. As a result, the layer made of the composite resin is formed above and below the fine particles, which advances the formation of the protrusion portions. Thus, since even a small amount of fine particles advance the formation of the protrusion portions to impart desired anti-blocking properties, it is considered that a reduction in the haze of the hard coat layer can be achieved. Furthermore, in addition to such an action in the thickness direction of the hard coat layer that the sedimentation of the fine particles is prevented, an action in a plane direction in which the fine particles are uniformly dispersed in the plane of the hard coat layer is also considered to contribute the haze reduction. That is, the inorganic component dispersed in the composite resin acts on the fine particles so as to provide steric hindrance, which provides a decrease in the possibility of contact or extreme proximity between the fine particles. As a result, the formation of the unevenness having large undulation caused by the aggregation of the fine particles is suppressed. This is considered to contribute to the maintenance or improvement of transparency. The action in the plane direction simultaneously contributes to the suppression of the defects such as the coarse projections formed by the over-aggregation of the fine particles. Also at this point, it is considered that the action contributes to the maintenance or improvement of transparency. The mechanism for suppressing the haze is not limited to the above, and as long as the effect of the present invention is obtained, other mechanisms can also be independently or comprehensively employed.

It is preferable that a mode diameter P [μm] of the fine particles and a thickness T [μm] of the flat portion satisfy P≧T. The relation facilitates the formation of the protrusion portions by the fine particles, and can exhibit desired anti-blocking properties.

It is preferable that the inorganic component is nanoparticles having a mode diameter of 1 nm or more and 100 nm or less. The use of the nanoparticles having a small mode diameter as the inorganic component is less likely to cause the scattering of visible light, and can suppress a large increase in the haze of the hard coat layer even when the refractive index of the organic component in the composite resin is different from that of the nanoparticles.

It is preferable that the inorganic component contains silicon oxide from the viewpoints of hardness, a refractive index, and stability.

It is preferable that the number of protrusion portions on the surface of the hard coat layer is 100/0.452 mm×0.595 mm or less. An increase in the haze H_{particle} caused by the protrusion portions can be suppressed by setting the number of protrusion portions to the above range.

The present invention includes also a hard coat film wound body obtained by winding a continuous length body including the hard coat film into a roll shape.

### BRIEF DESCRIPTION OF THE DRAWINGS

FIG. 1 is a schematic cross-sectional view of a hard coat film according to one embodiment of the present invention.

FIG. 2 is a schematic cross-sectional view of a transparent conductive film according to another embodiment of the present invention.

FIG. 3 is a cross-sectional SEM image of a protrusion portion of a hard coat film of Example 1.

FIG. 4 is a cross-sectional SEM image of a protrusion portion of a hard coat film of Comparative Example 1.

### MODE FOR CARRYING OUT THE INVENTION

### First Embodiment

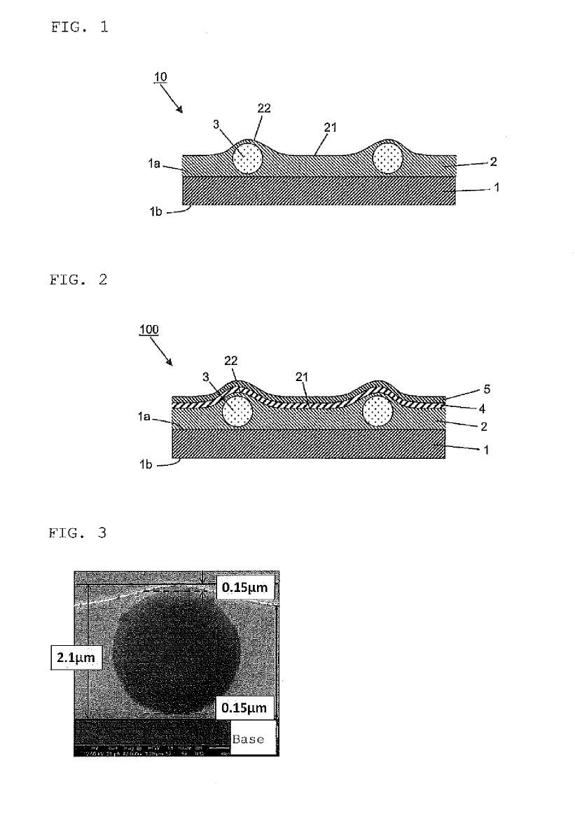

A first embodiment which is one embodiment of the present invention will be described below with reference to the drawings. FIG. 1 is a schematic cross-sectional view showing a hard coat film according to one embodiment of the present invention. A hard coat film 10 includes a transparent polymer base material 1 and a hard coat layer 2 formed on one surface 1a of the transparent polymer base material 1. The hard coat layer 2 has a surface having a flat portion 21 and protrusion portions 22 formed by fine particles 3.

### <Transparent Polymer Base Material>

The transparent polymer base material 1 is not particularly limited, and various kinds of plastic films having transparency are used. Examples of the material thereof include a polyester-based resin, an acetate-based resin, a polyether sulfone-based resin, a polycarbonate-based resin, a polyamide-based resin, a polyimide-based resin, a polyolefin-based resin, a polycycloolefin-based resin such as a polynorbornene-based resin, a (meth)acryl-based resin, a polyvinyl chloride-based resin, a polyvinylidene chloride-based resin, a polystyrene-based resin, a polyvinyl alcohol-based resin, a polyarylate-based resin, a polyphenylene sulfide-based resin and a cellulose-based resin such as triacetylcellulose. Among them especially preferable are a polyester-based resin, a polycarbonate-based resin and a polyolefin-based resin.

The thickness of the transparent polymer base material 1 is preferably in a range of 2 to 200 μm, more preferably in a range of 2 to 100 μm. If the thickness of the transparent polymer base material 1 is less than 2 μm, the mechanical strength of the transparent polymer base material 1 may become insufficient, thus making it difficult to perform an operation to continuously form the transparent conductive layer 5 with the film base material formed in a roll shape. On the other hand, if the thickness is more than 200 μm, the scratch resistance of the transparent conductive layer 5 and dotting property as intended for use in a touch panel may not be improved.

The surface of the transparent polymer base material may be subjected beforehand to an etching treatment or a undercoating treatment such as sputtering, corona discharge, flame, ultraviolet-ray irradiation, electron-beam irradiation, chemical conversion or oxidation to improve adhesion between the transparent polymer base 1 and the hard coat layer 2 formed thereon. The surface of the transparent polymer base material may be freed from dust and cleaned by solvent cleaning or ultrasonic cleaning as necessary before the hard coat layer 2 is formed.

### <Hard Coat Layer>

The hard coat layer 2 which includes fine particles and a composite resin containing an organic component and an inorganic component is provided on the transparent polymer base material 1. The hard coat layer has a surface having the flat portion 21 and the protrusion portions 22 provided by the fine particles 3.

In the hard coat layer 2, a fine particle sedimentation suppressive action of the composite resin containing the organic component and the inorganic component suppresses the sedimentation of the fine particles 3 to the transparent polymer base material 1 side, which allows the fine particles 3 to remain on the exposed surface side. Therefore, the fine particles 3 exist in a state where the fine particles 3 are not brought into contact with the transparent polymer base material 1, in other words, in a state where the fine particles 3 float in the hard coat layer 2. Furthermore, a steric hindrance action of the composite resin to the fine particles suppresses contact or extreme proximity between the fine particles 3, which provides the dispersion of the fine particles 3 in the hard coat layer 2 at moderate intervals. However, as long as the effect of the present invention is obtained, some fine particles 3 may be brought into contact with the transparent polymer base material 1, or some fine particles 3 may be brought into contact or extreme proximity with each other.

Haze H_{particle} caused by the protrusion portions 22 of the hard coat layer 2 should be 0.5% or less. The haze H_{particle} is preferably 0.4% or less, and more preferably 0.3% or less. The haze H_{particle} exceeding 0.5% causes deterioration in the visible light transmittance in the whole hard coat film 10. For example, when the hard coat film is applied to a transparent conductive film, image sharpness is deteriorated, which tends to be apt to cause blurred characters or the like on a display screen. The suitable lower limit of the haze H_{particle} is 0%, and may be 0.1% or more under the influence of the existence of the fine particles 3.

The haze Hₜₒₜₐₗ of the hard coat film 10 is preferably 5% or less, more preferably 4% or less, and still more preferably 3% or less. When the haze Hₜₒₜₐₗ of the hard coat film is increased, the image sharpness is deteriorated by the scattering of light as in the case of the haze H_{particle} which tends to be apt to cause the blurred characters or the like on the display screen. The haze is measured in accordance with JISK 7136 (2000 edition). The suitable lower limit of the haze Hₜₒₜₐₗ of the hard coat film is 0%. However, since the hard coat layer 2 contains the fine particles 3, the haze Hₜₒₜₐₗ is generally 0.3% or more in many cases.

When the number of protrusion portions 22 on the surface of the hard coat layer 2 is excessively increased, the occurrence of blocking tends to be suppressed. However, light is scattered due to the unevenness, and for example, the definition of the screen tends to be decreased when the hard coat layer 2 is applied to a touch panel or the like. Conversely, when the number of protrusion portions 22 is decreased, and the surface comes close to a smoothing state, anti-blocking properties are apt to be deteriorated. Therefore, from the viewpoints of sufficiently imparting the anti-blocking properties to the hard coat film 10 and sufficiently suppressing an increase in the haze, the number of protrusion portions 22 on the surface of the hard coat layer 2 is preferably 100/0.452 mm×0.595 mm or less, and is preferably 10/0.452 mm×0.595 mm or more.

The surface shape and haze value of the hard coat layer can be adjusted to the above ranges by suitably adjusting the combination of the composite resin and fine particles which form the hard coat layer 2, and the thickness of the hard coat layer. Hereinafter, preferable aspects of the composite resin and fine particles which form the hard coat layer 2 will be described.

### (Composite Resin)

The composite resin contains the organic component and the inorganic component. Since the composite resin contains the inorganic component and the organic component, the hard coat layer 2 can suitably exhibit an action provided by the inorganic component, i.e., a fine particle sedimentation suppressive action, a fine particle contact suppressive action, and a hardness imparting action or the like.

### (Organic Component)

An ultraviolet curable resin, a thermosetting resin, and a thermoplastic resin or the like are used as the organic component without particular limitation. From the viewpoint of a fast processing speed, and suppressing thermal damage of the transparent polymer base material 1, the ultraviolet curable resin is particularly preferably used.

For example, a curable compound having at least one of an acrylate group and a methacrylate group which is curable by light (ultraviolet rays) can be used as such an ultraviolet curable resin. Examples of the curable compound include a silicone resin, a polyester resin, a polyether resin, an epoxy resin, an urethane resin, an alkyd resin, a spiroacetal resin, a polybutadiene resin, a polythiol-polyene resin, and oligomers or prepolymers of acrylate and methacrylate or the like of a multifunctional compound such as a polyhydric alcohol. These may be used alone or in a combination of two or more of them.

A reactive diluent may be contained in addition to each of the components as the ultraviolet curable resin used for the organic component of the composite resin. For example, a reactive diluent having at least one of an acrylate group and a methacrylate group can be used as the reactive diluent. A reactive diluent described in, for example, JP-A-2008-88309 can be used as the specific example of the reactive diluent. Examples thereof include monofunctional acrylate, monofunctional methacrylate, polyfunctional acrylate, and polyfunctional methacrylate. The reactive diluent is preferably trifunctional or higher-functional acrylate or trifunctional or higher-functional methacrylate. This is because they can improve the hardness of the hard coat layer. Another examples of the reactive diluent include butanediol glycerin ether diacrylate; acrylate of isocyanuric acid; and methacrylate of isocyanuric acid. These may be used alone or in a combination of two or more of them.

### (Inorganic Component)

The composite resin contains an organic component such as an ionizing radiation curable resin, and an inorganic component. Examples of the inorganic component include fine particles or fine powder made of inorganic oxide such as silicon oxide (silica), titanium oxide, aluminum oxide, zinc oxide, tin oxide, and zirconium oxide or the like. Among them, from the viewpoint of controlling the refractive index of the hard coat layer, the fine particles made of silicon oxide (silica), titanium oxide, aluminum oxide, zinc oxide, tin oxide, and zirconium oxide are preferable, and silicon oxide is particularly preferable. These may be used alone or in a combination of two or more of them.

From the viewpoints of the coloring prevention and transparency of the hard coat layer, the inorganic component used for the composite resin is nanoparticles having a mode diameter of preferably 1 nm to 100 nm, more preferably 5 nm to 80 nm, and still more preferably 10 nm to 60 nm. Thus, the mode diameter of the nanoparticles is small, which prevents the scattering of the visible light. Even when the refractive index of the organic component in the composite resin is different from that of the nanoparticles, a large increase in the haze of the hard coat layer is suppressed.

Herein, the “mode diameter” means a particle diameter representing the maximum value of a particle distribution. The mode diameter of the nanoparticles is obtained by measurement under a predetermined condition using a dynamic light scattering method (a nanoparticle size distribution measuring device “Nanotrac UPA-EX150” (product name) manufactured by Nikkiso Co., Ltd.). A measurement sample diluted to 10% by weight with methyl ethyl ketone is measured.

The inorganic oxide nanoparticles are preferably surface-modified with an organic compound having a polymerizable unsaturated group. The unsaturated group is reacted with the organic component in the composite resin to be cured, which can provide an increase in hardness of the hard coat layer. Preferable examples of the polymerizable unsaturated group in the organic compound with which the inorganic oxide nanoparticles are surface-modified include a (meth)acryloyl group, a vinyl group, a propenyl group, a butadienyl group, a styryl group, an ethynyl group, a cinnamoyl group, a maleate group, and an acrylamide group. The organic compound having the polymerizable unsaturated group may be a compound having a silanol group inside its molecule or a compound producing a silanol group through hydrolysis. It is preferable that the organic compound having the polymerizable unsaturated group has a photosensitive group.

The amount of the inorganic oxide nanoparticles contained in the composite resin is preferably 50 parts by weight to 300 parts by weight, and more preferably 100 parts by weight to 200 parts by weight based on 100 parts by weight of an organic component solid content such as the ionizing radiation curable resin. By setting the amount of the inorganic oxide nanoparticles contained in the composite resin to the above range, a fine particle sedimentation suppressive action, a fine particle contact suppressive action, and a hardness imparting action in the hard coat layer can be suitably exhibited. For example, the refractive index of the hard coat layer can also be adjusted.

Since the nanoparticles have a small particle diameter, the nanoparticles do not directly contribute to the formation of the protrusion portions 22 on the surface of the hard coat layer 2, but act as the composition of the composite resin. Therefore, the nanoparticles in the hard coat layer 2 are not included as the fine particles 3 to be described later.

### (Fine Particles)

For fine particles 3 that are used in the hard coat layer 2, those having transparency, such as various kinds of metal oxides, glass and plastic, can be used without particular limitation. Examples thereof include inorganic fine particles such as silica, alumina, titanium, zirconia and calcium oxide, crosslinked or uncrosslinked organic fine particles formed of various kinds of polymers such as polymethyl methacrylate, polystyrene, polyurethane, acryl-based resins, acryl-styrene copolymers, benzoguanamine, melamine and polycarbonate, and silicone-based fine particles. One kind or two or more kinds of particles can be appropriately selected from the aforementioned particles, and used.

The surface shape of the hard coat layer 2 can be adjusted by the mode diameter and content or the like of the fine particles 3 in the hard coat layer. In order to form the protrusion portions 22 on the surface of the hard coat layer 2 from the fine particles 3, it is preferable that the mode diameter P [μm] of the fine particles 3 and the thickness T [μm] of the flat portion 21 satisfy P≧T.

The mode diameter of the fine particles should be set in consideration of the relation with the thickness of the flat portion of the hard coat layer, and is preferably 0.5 μm to 3.0 μm, more preferably 1.0 μm to 2.5 μm, and still more preferably 1.5 μm to 2.0 μm. When the mode diameter of the fine particles of the hard coat layer is greater than the range, a curl tends to occur in the hard coat layer. On the other hand, when the mode diameter of the fine particles is smaller than the range, sufficient hardness cannot be imparted to the hard coat layer as the case may be.

The mode diameter of fine particles can be determined by making a measurement under predetermined conditions (Sheath liquid: ethyl acetate, measurement mode: HPF measurement, measurement method: total count) using a flow-type particle image analyzer (manufactured by Sysmex Corporation, trade name “FPTA-3000S”). Fine particles are diluted to 1.0% by weight with ethyl acetate, and uniformly dispersed using an ultrasonic cleaning machine, and the dispersion thus obtained is used as a measurement sample.

The shape of the fine particles 3 is not particularly limited. For example, the fine particles 3 may have a substantially spherical shape like beads, or may have an indefinite shape like powder or the like. Preferably, the fine particles 3 have a substantially spherical shape, more preferably a substantially spherical shape with an aspect ratio of 1.5 or less, and most preferably a spherical shape. When fine particles having an aspect ratio exceeding 1.5, and polygonal fine particles are used, coarse protrusion portions are apt to be formed on the surface of the hard coat film, which may make it difficult to achieve an improvement in resistance to pen-input.

In the present embodiment, the fine particles 3 are preferably monodisperse fine particles having a single particle size distribution. From the viewpoint of simplifying the particle size distribution of the fine particles, only one type of fine particles is preferably used. When the fine particles have a single particle size distribution, the surface shape of the hard coat layer is easily controlled to a predetermined shape. When the fine particles are the monodisperse fine particles, the particle diameter of the fine particles can be regarded as the mode diameter as it is.

The ratio of the fine particles 3 contained in the hard coat layer 2 is not particularly limited, and can be suitably set to 0.01 parts by weight to 3 parts by weight based on 100 parts by weight of the composite resin while the specific gravity of the composite resin and the thickness of the hard coat layer or the like are considered.

The refractive index n_{particle} of the fine particles 3 is preferably smaller than the refractive index nᵣₑₛᵢₙ of the composite resin, and preferably satisfies the relation of the following formula (1):

−0.1≦n_{particle}−nᵣₑₛᵢₙ≦−0.02 (1).

When n_{particle}−nᵣₑₛᵢₙ is negative (when the refractive index of the fine particles is smaller than the refractive index of the composite resin), a good anti-glare performance tends to be obtained as compared with the case where n_{particle}−nᵣₑₛᵢₙ is positive (when the refractive index of the fine particles is greater than the refractive index of the composite resin). Particularly, when the refractive index difference is made greater than 0.02, anti-glare can be achieved by adding a small amount of fine particles. On the other hand, if the refractive index difference exceeds 0.1, the scattering of light caused by the hard coat layer 2 is increased, which may be apt to cause an increase in the haze.

### (Additive Agent)

The material for forming the hard coat layer 2 may further contain various kinds of additive agents in addition to the composite resin and the fine particles. For example, a polymerization initiator for curing the composite resin to form the hard coat layer, a leveling agent, a pigment, a filler, a dispersing agent, a plasticizer, an ultraviolet absorbing agent, a surfactant, an antioxidant, and a thixotropy-imparting agent or the like can be used as the additive agent.

Conventionally known photopolymerization initiators can be used as the polymerization initiator. For example, there can be used 2,2-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzyl dimethyl ketal, N,N,N,N-tetramethyl-4,4′-diaminobenzophenone, 1-(4-isopropylphenyl)-2-hydroxy-2-methylpropane-1-one, and other thioxanthone compounds or the like.

A fluorine or silicone leveling agent can be suitably used as the leveling agent. The leveling agent is more preferably a silicone leveling agent. Examples of the silicone leveling agent include polydimethylsiloxane, polyether-modified polydimethylsiloxane, and polymethylalkylsiloxane. The additive amount of the fluorine or silicone leveling agent is preferably 0.01 to 5 parts by weight based on a total of 100 parts by weight of the solid content of the organic component and inorganic component in the composite resin.

The solvent for dispersing the fine particles 3 is not particularly limited as long as the solvent has no effect on a dispersion state and dissolves the organic component of the composite resin. Specific examples of the solvent include alcohols such as methanol, ethanol, and isopropyl alcohol; ketones such as acetone and methyl ethyl ketone; esters such as methyl acetate and butyl acetate; and toluene. These solvents may be used alone, or may be mixed at an appropriate ratio.

In order to form the hard coat layer 2, there can be used a suitable method such as a method of adding the fine particles into the composite resin, coating the transparent polymer base material 1 with the composite resin, and drying the composite resin, followed by a curing treatment, to form the protrusion portions provided by the added fine particles 3. Examples of the coating method include, but are not particularly limited to, known methods such as a fountain coating, a die coating, a spin coating, a spray coating, a gravure coating, a roll coating, and a bar coating.

Examples of the curing treatment include an energy irradiation method. For example, there are used radiation sources such as a high-pressure mercury lamp, a halogen lamp, a xenon lamp, a metal halide lamp, a nitrogen laser, an electron beam accelerator, and a radioactive element as the energy radiation source. The amount of irradiation with the energy radiation source is preferably 50 to 5000 mJ/cm² in terms of accumulative exposure at an ultraviolet wavelength of 365 nm. When the amount of irradiation is less than 50 mJ/cm², insufficient curing is caused, which causes a decrease in the hardness of the hard coat layer 2. When the amount of irradiation exceeds 5000 mJ/cm², the hard coat layer 2 is colored, which causes deterioration in transparency.

The thickness of the flat portion 21 of the hard coat layer 2 is preferably 0.5 μm to 5.0 μm from the viewpoints of coating properties and hardness. When the thickness of the hard coat layer is greater than the range, a curl tends to occur in the transparent polymer base material after the hard coat layer is formed, or the haze tends to be increased. On the other hand, when the thickness of the hard coat layer is smaller than the range, glare cannot be sufficiently suppressed in a touch panel formed of the hard coat layer as the case may be, or the hard coat layer does not have sufficient hardness, which is apt to cause flaws in the hard coat layer as the case may be.

### Second Embodiment

A second embodiment which is another embodiment of the present invention will be described below with reference to the drawings. FIG. 2 is a schematic cross-sectional view showing a transparent conductive film according to the second embodiment of the present invention. In a transparent conductive film 100, a dielectric thin film 4 and a transparent conductive layer 5 are formed in order on the hard coat layer 2 of the hard coat film 10 according to the first embodiment.

### <Dielectric Thin Film>

As shown in FIG. 2, the dielectric thin film 4 may be provided between the hard coat layer 2 and the transparent conductive layer 5 for the purpose of controlling adhesion and reflection property of the transparent conductive layer, and so on. The dielectric thin film may be a single layer, or two or more layers may be provided. The dielectric thin film is formed of an inorganic substance, an organic substance or a mixture of an inorganic substance and an organic substance. Examples of the material that forms the dielectric thin film include inorganic substances such as NaF, Na₃AlF₆, LiF, MgF₂, CaF₂, SiO₂, LaF₃, CeF₃, Al₂O₃, TiO₂, Ta₂O₅, ZrO₂, ZnO, ZnS and SiOₓ (x is 1.5 or more and less than 2), and organic substances such as an acryl resin, an urethane resin, a melamine resin, an alkyd resin and a siloxane-based polymer. As the organic substance, in particular, it is preferred to use a thermosetting resin formed of a mixture of a melamine resin, an alkyd resin and an organic silane condensate. The dielectric thin film can be formed by a vacuum deposition method, a sputtering method, an ion plating method or a coating method using the material described above.

The thickness of the dielectric thin film 4 is preferably 5 nm to 150 nm, more preferably 10 nm to 100 nm, further preferably 20 nm to 70 nm. If the thickness of the dielectric thin film is excessively small, a continuous film is hard to be formed. If the thickness of the dielectric thin film is excessively large, transparency of the transparent conductive film may be deteriorated, or the dielectric thin film may be easily cracked.

Since the thickness of the dielectric thin film 4 is smaller than the thickness of the flat portion 21 of the hard coat layer 2 in the present embodiment, the surface shape of the hard coat layer 2 is mostly maintained also on the surface of the dielectric thin film 4.

### <Transparent Conductive Layer>

The transparent conductive layer 5 is formed on the hard coat layer 2. When the dielectric thin film 4 is formed on the hard coat layer 2 as shown in FIG. 2, the transparent conductive layer 5 is formed on the dielectric thin film 4. The constituent material of the transparent conductive layer 5 is not particularly limited, and a metal oxide of at least one metal selected from the group consisting of indium, tin, zinc, gallium, antimony, titanium, silicon, zirconium, magnesium, aluminum, gold, silver, copper, palladium and tungsten is suitably used. The metal oxide may further contain metal atoms shown in the above-mentioned group as necessary. For example, indium oxide containing tin oxide (ITO), tin oxide containing antimony (ATO), and the like are preferably used.

The thickness of the transparent conductive layer 5 is not particularly limited, but is preferably 10 nm or more for forming a continuous film having such a good conductivity that its surface resistance is no higher than 1×10³Ω/□. If the thickness is excessively large, the transparency is deteriorated, and therefore the thickness is preferably 15 to 35 nm, more preferably in a range of 20 to 30 nm. If the thickness of the transparent conductive layer is less than 15 nm, the electric resistance of the film surface increases, and a continuous film is hard to be formed. If the thickness of the transparent conductive layer is more than 35 nm, deterioration of transparency or the like may be caused.

The method for forming the transparent conductive layer 5 is not particularly limited, and a previously known method can be employed. Specifically, for example, dry processes such as a vacuum deposition method, a sputtering method and an ion plating method can be shown as an example. An appropriate method can also be employed according to a required thickness. When the transparent conductive layer 5 is formed on the hard coat layer 2 forming surface side as shown in FIG. 2, the surface of the transparent conductive layer 5 almost maintains the shapes of the protrusion portions of the surface of the hard coat layer 2 which is a ground layer thereof if the transparent conductive layer 5 is formed by a dry process such as a sputtering method. Therefore, even when the transparent conductive layer 5 is formed on the hard coat layer 2, blocking resistance and slidability can be suitably imparted to the surface of the transparent conductive layer 5 as well.

The transparent conductive layer 5 can be crystallized by being subjected to a heating annealing treatment as necessary. When the transparent conductive layer is crystallized, the resistance of the transparent conductive layer is reduced, and also transparency and durability are improved.

### Another Embodiment

The transparent conductive film obtained as described above may be used to form a touch panel as it is. An antireflection layer for the purpose of achieving an improvement in visibility may be provided on a surface 1b (see FIG. 1) opposite to the surface on which the transparent conductive layer 5 of the transparent polymer base material 1 is formed, or a back surface hard coat layer may be provided for the purpose of protecting the outer surface. The back surface hard coat layer and the antireflection layer or the like can also be formed on the transparent polymer base material either before or after the transparent conductive layer is formed. The antireflection layer can also be provided on the back surface hard coat layer.

The transparent conductive film of the present embodiment is suitably used in order to form the transparent electrode for various devices and the touch panel.

### EXAMPLES

Hereinafter, the present invention will be described in detail with reference to Examples. However, the present invention is not limited to the following Examples without departing from the purport. “Content” and “ratio” in each Example are on a weight basis if not otherwise specified.

### Example 1

### Preparation of Coating Liquid for Forming Hard Coat Layer

There were mixed 100 parts by weight of polyfunctional urethane acrylate (“OPSTAR 27540” (product name) manufactured by JSR Corporation) in which an inorganic component (150 parts by weight of silica nanoparticles having a mode diameter of 40 nm based on 100 parts by weight of the following acrylate component) was dispersed, as a composite resin, 3.0 parts by weight of a photopolymerization initiator (“Irgacure 184” (product name) manufactured by Ciba Specialty Chemicals), 0.06 parts by weight of monodisperse light diffusing particles (MX-180 TA (product name), acrylic bead manufactured by Soken Chemical & Engineering Co., Ltd., mode diameter of 1.8 μm) as fine particles, and 0.05 parts by weight of a surface adjusting agent (“GRANDIC PC4100” (product name) manufactured by DIC corporation). A coating liquid for forming a hard coat layer was prepared such that a solid content was 15% using butyl acetate.

### (Formation of Hard Coat Film)

The prepared coating liquid for forming a hard coat layer was applied on a COP (cycloolefin polymer) film (“ZEONOR ZF-16” (product name) manufactured by ZEON CORPORATION) having a thickness of 100 μm as a transparent polymer base material using a wire bar #6. The coating liquid was dried under an atmosphere of 60° C. for 1 min in a dry oven, to volatilize a solvent. Then, the applied film was cured by irradiating the applied film with UV rays at an illuminance of 40 mW/cm² and an irradiation amount of 250 mJ/cm² using an air-cooled mercury lamp (manufactured by Eye Graphics Co., Ltd.) of 160 W/cm under an atmosphere having an oxygen concentration of 2500 ppm, to form a hard coat layer (the thickness of a flat portion: 1.5 μm), thereby obtaining a hard coat film.

### Example 2

A hard coat film was produced in the same manner as in Example 1 except that a mode diameter of monodisperse fine particles was set to 3 μm (“SSX103DXE” (product name) manufactured by Sekisui Plastics Co., Ltd.), and the thickness of a flat portion of a hard coat layer was set to 2 μm in Example 1.

### Example 3

A hard coat film was produced in the same manner as in Example 1 except that the amount of fine particles contained in 100 parts by weight of a composite resin was set to 0.1 parts by weight, and the thickness of a flat portion of a hard coat layer was set to 1.8 μm in Example 1.

### Example 4

A hard coat film was produced in the same manner as in Example 1 except that, in Example 1, 100 parts by weight of polyfunctional urethane acrylate (“OPSTAR KZ6661” (product name) manufactured by JSR Corporation) in which an inorganic component (zirconia nanoparticles, mode diameter: 10 nm, 150 parts by weight based on 100 parts by weight of the following acrylate component) was dispersed as a composite resin was used, and the thickness of a flat portion of a hard coat layer was set to 1.8 μm in Example 1.

### Example 5

A hard coat film was produced in the same manner as in Example 1 except that 100 parts by weight of polyfunctional urethane acrylate (“OPSTAR KZ6661” (product name) manufactured by JSR Corporation) in which an inorganic component (zirconia nanoparticles, mode diameter: 10 nm, 150 parts by weight based on 100 parts by weight of the following acrylate component) was dispersed as a composite resin was used, the amount of fine particles contained in 100 parts by weight of a composite resin was set to 0.02 parts by weight, and the thickness of a flat portion of a hard coat layer was set to 1.6 μm in Example 1.

### Example 6

A hard coat film was produced in the same manner as in Example 1 except that 100 parts by weight of polyfunctional urethane acrylate (“OPSTAR KZ6661” (product name) manufactured by JSR Corporation) in which an inorganic component (zirconia nanoparticles, mode diameter: 10 nm, 150 parts by weight based on 100 parts by weight of the following acrylate component) was dispersed as a composite resin was used, the amount of fine particles contained in 100 parts by weight of a composite resin was set to 0.02 parts by weight, and the thickness of a flat portion of a hard coat layer was set to 1.4 μm in Example 1.

### Example 7

A hard coat film was produced in the same manner as in Example 1 except that a PET (polyethylene terephthalate) film having a thickness of 50 μm (“Dia Foil E80T602” (product name) manufactured by Mitsubishi Plastics Industries, Ltd.) was used as a transparent polymer base material in Example 1.

### Comparative Example 1

A hard coat film was produced in the same manner as in Example 1 except that 100 parts by weight of an UV curable polymer type acrylate resin (“UNIDIC RC29-120” (product name) manufactured by DIC corporation) was used as an organic resin component in place of the composite resin, and the thickness of a flat portion of a hard coat layer was set to 1.0 μm in Example 1.

### Comparative Example 2

A hard coat film was produced in the same manner as in Comparative Example 1 except that the amount of fine particles contained in 100 parts by weight of an organic resin component was set to 0.11 parts by weight in Comparative Example 1.

### Comparative Example 3

A hard coat film was produced in the same manner as in Comparative Example 1 except that the amount of fine particles contained in 100 parts by weight of an organic resin component was set to 0.16 parts by weight in Comparative Example 1.

### Comparative Example 4

A hard coat film was produced in the same manner as in Example 2 except that 100 parts by weight of an UV curable polymer type acrylate resin (“UNIDIC RC29-120” (product name) manufactured by DIC corporation) was used as an organic resin component in place of the composite resin in Example 2.

### Comparative Example 5

A hard coat film was produced in the same manner as in Comparative Example 4 except that the amount of fine particles contained in 100 parts by weight of an organic resin component was set to 0.1 parts by weight in Comparative Example 4.

### Comparative Example 6

A hard coat film was produced in the same manner as in Comparative Example 3 except that 100 parts by weight of an ultraviolet curable resin (“GRANDIC PC-1070” (product name) manufactured by Dainippon Ink & Chemicals, Inc.) was used as an organic resin component in Comparative Example 3.

### Comparative Example 7

A hard coat film was produced in the same manner as in Comparative Example 1 except that 100 parts by weight of PETA (pentaerythritol triacrylate) resin (“Biscoat #300” (product name) manufactured by Osaka Organic Chemical Industry Ltd.) was used as an organic resin component in Comparative Example 1.

### Comparative Example 8

A hard coat film was produced in the same manner as in Comparative Example 7 except that the amount of fine particles contained in 100 parts by weight of an organic resin component was set to 0.16 parts by weight in Comparative Example 7.

### Comparative Example 9

A hard coat film was produced in the same manner as in Comparative Example 7 except that the amount of fine particles contained in 100 parts by weight of an organic resin component was set to 0.02 parts by weight, and the thickness of a flat portion of a hard coat layer was set to 0.8 μm in Comparative Example 7.

### Comparative Example 10

A hard coat film was produced in the same manner as in Comparative Example 9 except that the thickness of a flat portion of a hard coat layer was set to 1.1 μm in Comparative Example 9.

### Comparative Example 11

A hard coat film was produced in the same manner as in Comparative Example 9 except that the thickness of a flat portion of a hard coat layer was set to 1.5 μm in Comparative Example 9.

### Example 12

A hard coat film was produced in the same manner as in Example 7 except that the amount of fine particles contained in 100 parts by weight of a composite resin was set to 0.02 parts by weight, and the thickness of a flat portion of a hard coat layer was set to 1.9 μm in Example 7.

### Comparative Example 13

A hard coat film was produced in the same manner as in Example 1 except that the amount of fine particles contained in 100 parts by weight of an organic resin component was set to 0.1 parts by weight in Example 1.

### Comparative Example 14

A hard coat film was produced in the same manner as in Example 1 except that the amount of fine particles contained in 100 parts by weight of an organic resin component was set to 0.12 parts by weight in Example 1.

### [Evaluation Method]

### (Evaluation of Anti-Blocking Properties (AB Properties))

A film having high smoothing properties (“ZEONOR film ZF-16” (product name) manufactured by ZEON CORPORATION) was pressure-bonded to the surface of the hard coat layer of the produced hard coat film by finger pressure, and the adhesion degree of the film was evaluated based on the following criteria.

### <Evaluation Criteria>

◯: The film did not adhere.

Δ: The film adhered once, but the film was separated as time advanced.

x: The film kept adhering as it was without being separated.

### (Measurement of Haze H_{particle} Caused by Protrusion Portions of Hard Coat Layer)

The coating liquid for forming a hard coat layer used in each of Examples and Comparative Examples was applied to a film (COP film) having no external haze, and cured to form a hard coat layer, thereby producing a hard coat film. Next, according to JIS K7136, the haze Hₜₒₜₐₗ of the produced hard coat film was measured by a haze meter (“HM-150” manufactured by manufactured by Murakami Color Research Laboratory). Then, the resin component used in each of Examples and Comparative Examples as a resin having the same refractive index as that of the binder resin of the hard coat layer was applied on the hard coat layer such that the protrusion portions disappeared, and cured. The haze H_{flat} of the sample in which the protrusion portions disappeared was measured as in the above, and the haze H_{particle} caused by the protrusion portions formed by the fine particles was obtained by subtracting the haze H_{flat} from the haze Hₜₒₜₐₗ. The procedure is based on that the haze is caused by the unevenness of an object to be measured. The haze caused by the protrusion portions of the hard coat layer can be independently measured by subtracting the haze of the sample in which the protrusion portions disappeared from the haze of the sample in which the protrusion portions exist.

### (Evaluation of Scratch Resistance (Sw Test))

Steel wool (#0000) of about 1 cm² was slid 10 times on the surface of the hard coat layer of the produced hard coat film while a load of 100 g was applied to the steel wool, and the scratch degree of the hard coat film was then evaluated by visual observation based on the following criteria.

### <Evaluation Criteria>

◯: no scratch

Δ: two or three hairline scratches

x: a large number of scratches

### (Evaluation of Transparency)

The produced hard coat film was visually tested for transmission, and the transparency of the hard coat film was determined based on the following criteria.

### <Evaluation Criteria>

◯: nearly transparent

Δ: slightly opaque

x: very opaque

### (Measurement of Transmission Clarity)

Transmission clarity was measured based on JIS K7105. That is, a measurement sample was cut out in a size of 50 mm×50 mm from the produced hard coat film. The measurement sample was set in a clarity measuring device (“ICM-1” manufactured by Suga Test Instruments Co., Ltd.). An optical comb was moved in the range of a predetermined width of an optical comb relative to light being transmitted through the measurement sample, and a maximum wave height (M) and a minimum wave height (m) on a record paper were read. The measurement sample was measured in the lengthwise and transverse directions of the measurement sample. The measurement results were obtained as follows. Specifically, the maximum wave height (M) and the minimum wave height (m) were obtained for each of widths of 0.125 mm, 0.5 mm, 1.0 mm, and 2.0 mm of the optical comb. Then, the transmission clarity C for each of the widths was calculated based on the following formula from the obtained value, and a value obtained by adding all the transmission clarities for respective widths was taken as a measurement result.

C={(M−m)/(M+m)}×100

### (Counting of Protrusion Portions on Surface of Hard Coat Layer)

The shape of the surface of the hard coat layer of the produced hard coat film was measured with an optical three-dimensional surface shape measuring instrument (“Wyko-NT1100” manufactured by Bruker Corporation) using an internal lens (1.0×) and an external (object) lens (10×). The obtained image as the result of the shape measurement (0.452×0.595 mm square) was subjected to binarization processing using image-analysis software (“Azo kun (registered trademark)” manufacture by Asahi Kasei Engineering Corporation). Then, the binarized image was analyzed in a particle analysis mode, and the obtained number of particles was counted as the number of protrusion portions. In other words, in the image analysis, the protrusion portions dotted in the image as the result of the shape measurement were regarded as particles, and binarization processing and count processing were performed.

### (Mode Diameter of Nanoparticles)

As described above, the mode diameter of the nanoparticles was measured under a predetermined condition using a dynamic light scattering method (nanoparticle size distribution measuring device “Nanotrac UPA-EX150” (product name) manufactured by Nikkiso Co., Ltd.). The measurement sample diluted to 10% by weight with methyl ethyl ketone was measured.

### (Mode Diameter of Fine Particles)

As described above, the mode diameter of the fine particles was measured under a predetermined condition (Sheath liquid: ethyl acetate, measurement mode: HPF measurement, measurement method: total count) using a flow type particle image analysis device (“FPTA-3000S” (product name) manufactured by Sysmex Corporation).

### (Thickness of Hard Coat Layer)

The thickness of the hard coat film in which the hard coat layer containing the fine particles was provided on the transparent polymer base material was measured, and the thickness of the hard coat layer containing the fine particles was calculated by subtracting the thickness of the transparent polymer base material from the thickness of the hard coat film. The thickness was measured by a microgauge type thickness meter manufactured by Mitutoyo Corporation.

### (Cross-Sectional SEM Image of Protrusion Portions of Hard Coat Layer)

The cross-section of the protrusion portions in each of the hard coat films of Example 1 and Comparative Example 1 was observed by a scanning electron microscope (SEM) (“S-4800” manufactured by Hitachi, Ltd., at a magnification of 40000×).

### [Results]

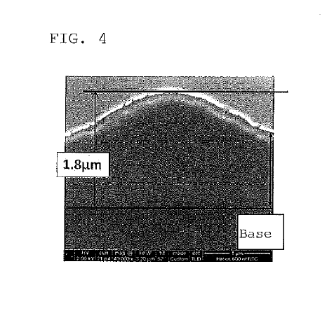

The constitutions and evaluation results of the hard coat layers of Examples and Comparative Examples are shown in Tables 1 and 2. The cross-sectional SEM images of the protrusion portions of Example 1 and Comparative Example 1 are respectively shown in FIGS. 3 and 4.

TABLE 1

| | | | | | | | Evaluation results | | | | | |
|---|---|---|---|---|---|---|---|---|---|---|---|---|
| | Constitution of hard coat layer | | | | | | | | | | | The |
| | | | | | | Thickness | | | | | | number of |
| | | | | Particle | Amount | of flat | AB | | | Transparency | Trans- | protrusion |
| | Resin | | | diameter | [part by | portion | proper- | H_{particle} | Sw | (visually | mission | portions |
| | Type | Product name | Base | [μm] | weight] | [μm] | ties | [%] | test | tested) | clarity | in plane |
| Example 1 | Organic- | Z7540 | COP | 1.8 | 0.06 | 1.5 | ∘ | 0.2 | ∘ | ∘ | 378.2 | 65 |
| | inorganic | | | | | | | | | | | |
| Example 2 | Organic- | Z7540 | COP | 3 | 0.06 | 2 | ∘ | 0.4 | ∘ | ∘ | 381.9 | 43 |
| | inorganic | | | | | | | | | | | |
| Example 3 | Organic- | Z7540 | COP | 1.8 | 0.1 | 1.8 | ∘ | 0.4 | ∘ | ∘ | 382.9 | 99 |
| | inorganic | | | | | | | | | | | |
| Example 4 | Organic- | KZ6661 | COP | 1.8 | 0.06 | 1.8 | ∘ | 0.1 | ∘ | ∘ | 377.5 | 85 |
| | inorganic | | | | | | | | | | | |
| Example 5 | Organic- | KZ6661 | COP | 1.8 | 0.02 | 1.6 | ∘ | 0 | ∘ | ∘ | 358.8 | 33 |
| | inorganic | | | | | | | | | | | |
| Example 6 | Organic- | KZ6661 | COP | 1.8 | 0.02 | 1.4 | ∘ | 0 | ∘ | ∘ | 363 | 39 |
| | inorganic | | | | | | | | | | | |
| Example 7 | Organic- | Z7540 | PET | 1.8 | 0.06 | 1.5 | ∘ | 0.1 | ∘ | ∘ | 361.4 | 77 |
| | inorganic | | | | | | | | | | | |

TABLE 2

| | | | | | | | Evaluation results | | | | | |
|---|---|---|---|---|---|---|---|---|---|---|---|---|
| Constitution of hard coat layer | | | | | | | | | | | | The |
| | | | | | | Thickness | | | | | | number of |
| | | | | Particle | Amount | of flat | AB | | | Transparency | Trans- | protrusion |
| | Resin | | | diameter | [part by | portion | proper- | H_{particle} | Sw | (visually | mission | portions |
| | Type | Product name | Base | [μm] | weight] | [μm] | ties | [%] | test | tested) | clarity | in plane |
| Comparative | Organic | UNIDIC RC29-120 | COP | 1.8 | 0.06 | 1.0 | x | 0.2 | ∘ | ∘ | 389.5 | 38 |
| Example 1 | | | | | | | | | | | | |
| Comparative | Organic | UNIDIC RC29-120 | COP | 1.8 | 0.11 | 1.0 | x | 0.4 | ∘ | ∘ | 390.5 | 70 |
| Example 2 | | | | | | | | | | | | |
| Comparative | Organic | UNIDIC RC29-120 | COP | 1.8 | 0.16 | 1.0 | ∘ | 0.7 | ∘ | ∘ | 388.1 | 129 |
| Example 3 | | | | | | | | | | | | |
| Comparative | Organic | UNIDIC RC29-120 | COP | 3 | 0.06 | 2.0 | x | 0.3 | ∘ | ∘ | 387.7 | 67 |
| Example 4 | | | | | | | | | | | | |
| Comparative | Organic | UNIDIC RC29-120 | COP | 3 | 0.1 | 2.0 | ∘ | 1 | ∘ | ∘ | 388.6 | 150 |
| Example 5 | | | | | | | | | | | | |
| Comparative | Organic | PC1070 | COP | 1.8 | 0.16 | 1.0 | ∘ | 0.2 | ∘ | x | 290.7 | 101 |
| Example 6 | | | | | | | | | | | | |
| Comparative | Organic | PETA | COP | 1.8 | 0.06 | 1.0 | ∘ | 0 | ∘ | x | 301.7 | 29 |
| Example 7 | | | | | | | | | | | | |
| Comparative | Organic | PETA | COP | 1.8 | 0.16 | 1.0 | ∘ | 0.2 | ∘ | x | 179.2 | 102 |
| Example 8 | | | | | | | | | | | | |
| Comparative | Organic | PETA | COP | 1.8 | 0.02 | 0.8 | ∘ | 0.2 | ∘ | x | 298.1 | 12 |
| Example 9 | | | | | | | | | | | | |
| Comparative | Organic | PETA | COP | 1.8 | 0.02 | 1.1 | ∘ | 0.2 | ∘ | x | 288.1 | 18 |
| Example 10 | | | | | | | | | | | | |
| Comparative | Organic | PETA | COP | 1.8 | 0.02 | 1.5 | x | 0 | ∘ | Δ | 312.8 | 18 |
| Example 11 | | | | | | | | | | | | |
| Comparative | Organic- | Z7540 | PET | 1.8 | 0.02 | 1.9 | x | 0 | ∘ | ∘ | 390.2 | — |
| Example 12 | inorganic | | | | | | | | | | | |
| Comparative | Organic- | Z7540 | COP | 1.8 | 0.1 | 1.5 | ∘ | 0.7 | ∘ | ∘ | — | 105 |
| Example 13 | inorganic | | | | | | | | | | | |
| Comparative | Organic- | Z7540 | COP | 1.8 | 0.12 | 1.5 | ∘ | 1 | ∘ | ∘ | — | 125 |
| Example 14 | inorganic | | | | | | | | | | | |

As shown in Table 1, the amount of the fine particles contained in each of the hard coat films according to Examples 1 to 7 was 0.1 parts by weight or less based on 100 parts by weight of the composite resin, and the number of protrusion portions in the predetermined range was also a small number of 100 or less. However, the hard coat films had good anti-blocking properties. Simultaneously, the hard coat films exhibited good anti-blocking properties and had small haze H_{particle}, which resulted in excellent scratch resistance and transparency.

On the other hand, as shown in Table 2, the thickness of the flat portion in Comparative Examples 1 and 2 using only the organic component as the binder for forming the hard coat layer was thinner than that in Example 1, and Comparative Examples 1 and 2 were considered to be apt to produce the protrusion portions. However, Comparative Examples 1 and 2 had no anti-blocking property. This seems to be because, since the organic resin component was used as the binder, fine particle sedimentation suppressive action was not achieved. Comparative Example 3 in which the amount of the fine particles was increased as compared with those in Comparative Examples 1 and 2 had anti-blocking properties. However, Comparative Example 3 had the increased haze H_{particle}. Comparative Example 4 had the same constitution as that of Example 2 except that only the organic component was used as the binder. However, Comparative Example 4 had no anti-blocking property. This seems to be because fine particle sedimentation suppressive action of the binder was not achieved. Comparative Example 5 in which the amount of the fine particles was increased as compared with that of Comparative Example 4 had anti-blocking properties. However, Comparative Example 5 had the increased haze H_{particle}. Comparative Examples 6 to 10 in which the organic resin component was changed had good anti-blocking properties, but resulted in poor transparency and transmission clarity. This seems to be because steric hindrance action of the binder on the fine particles was not achieved, which causes contact or extreme proximity between the fine particles to form large undulation on the surface. Comparative Example 11 had improved transparency as compared with those in Comparative Examples 9 and 10, but resulted in poor anti-blocking properties. In Comparative Example 12, the formation of the protrusion portions was not observed, and Comparative Example 12 had no anti-blocking property. This seems to be because the protrusion portions were not formed since the thickness of the flat portion of the hard coat layer was greater than the mode diameter of the fine particles. Comparative Examples 13 and 14 had the increased haze H_{particle} since the amount of the fine particles was excessive.

As shown in FIG. 3, the protrusion portion of the hard coat film of Example 1 had the layers made of the composite resin at the thickness of 1.5 μm above and below the fine particle, and had a height of 2.1 μm as a total thickness of the composite resin layers and the mode diameter, 1.8 μm, of the fine particles. On the other hand, as shown in FIG. 4, the protrusion portion of Comparative Example 1 had no layer made of the organic resin component above and below the fine particle, and the mode diameter, 1.8 μm, of the fine particles was the height of the protrusion portion as it is. As described above, it is found that the formation of the protrusion portions is advanced by using the composite resin containing the organic component and the inorganic component.

### DESCRIPTION OF REFERENCE SIGNS

1: transparent polymer base material
2: hard coat layer
21: flat portion
22: protrusion portions
3: fine particles
4: dielectric thin film
5: transparent conductive layer
10: hard coat film
100: transparent conductive film

1. A hard coat film comprising:
a transparent polymer base material; and
a hard coat layer formed on one main surface of the transparent polymer base material,
wherein:
the hard coat layer includes fine particles and a composite resin containing an organic component and an inorganic component;
the hard coat layer has a surface having a flat portion and protrusion portions formed by the fine particles; and
haze H_{particle} caused by the protrusion portions of the hard coat layer is 0.5% or less.

2. The hard coat film according to claim 1, wherein a mode diameter P [μm] of the fine particles and a thickness T [μm] of the flat portion satisfy P≧T.

3. The hard coat film according to claim 1, wherein the inorganic component is nanoparticles having a mode diameter of 1 nm or more and 100 nm or less.

4. The hard coat film according to claim 1, wherein the inorganic component contains silicon oxide.

5. The hard coat film according to claim 1, wherein the number of protrusion portions on the surface of the hard coat layer is 100/0.452 mm×0.595 mm or less.

6. A hard coat film wound body obtained by winding a continuous length body of the hard coat film according to claim 1 into a roll shape.
